(19) United States
(12) Patent Application Publication
(10) Pub. No.: US 2024/0383034 A1
(43) Pub. Date: Nov. 21, 2024

(54) SELECTIVE PARTICLE ENTRAPMENT AND APPLICATIONS THEREOF

(71) Applicant: University of Maine System Board of Trustees, Orono, ME (US)

(72) Inventors: Akm Bashir Khoda, Bangor, ME (US); S.M. Abu Naser Shovon, Orono, ME (US); Adeeb Ibne Alam, Orono, ME (US); MD Ibrahim Khalil, Orono, ME (US)

(21) Appl. No.: 18/689,616

(22) PCT Filed: Sep. 7, 2022
(86) PCT No.: PCT/US22/42709

§ 371 Date: Mar. 6, 2024

Related U.S. Application Data
(60) Provisional application No. 63/241,323, filed on Sep. 7, 2021.

(51) Int. Cl. B22F 7/04; B22F 7/06

(52) U.S. Cl. CPC B22F 7/04; B22F 7/064; B22F 2999/00

(57) ABSTRACT

Methods for selectively entrapping particles are disclosed. In some embodiments. a method for selectively entrapping particles includes providing a substrate at least partially submerged in a solution including a solute and solvent, where particles are dispersed in the solution. An interfacial layer may be formed on a surface of the substrate from the solute, for example spontaneously. The solute may be a polymer binder. The particles may then be entrapped in the interfacial layer. Thus, the particles may be dispersed in the solution and entrapped out of the solution. Entrapping may include applying a balance of viscous force and centrifugal force to the particles.

### CROSS-REFERENCE TO RELATED APPLICATION

This application claims the benefit of U.S. Provisional Patent Application No. 63/241,363, filed on Sep. 7, 2021, the content of which is hereby incorporated by reference herein in its entirety.

### BACKGROUND

The gravitational force has a negligible effect on sub-micron particles. Such particles often can adhere to solid substrates almost effortlessly. This is due to the adhesion force between the particle and the substrate, which can result from one or more of the attraction forces (e.g., van der Waals and electrostatic forces, covalent and acid-base interactions or surface asperities). However, when the gravitational force becomes prominent, a binder may be required to attach particles to the substrate. Both micro and nanoparticles are carried toward the receiver substrate using the carrier media (whether gas, solid or liquid) and particles are transferred following the force balance equilibrium (e.g., interfacial entropy). For example, color pigment (metal oxide) can travel through gas to deposit on a substrate in a dry printing process. Similarly, in a contact-transfer printing process, a donor substrate (often an elastomeric stamp) carries particles and transfers them to a receiver substrate upon contact. In a wet deposition technique, particles are added to a liquid, which carries and delivers the particles to the desired site using transfer processes such as Langmuir-Blodgett, dip coating, and spin-coating. The resultant liquid carrier system (LCS) can be of various forms, such as a solution, a sol-gel, a colloid, a slurry, a suspension, or a heterogeneous mixture. Organic nanoparticles (e.g., a polymer chain) or inorganic nanoparticles (e.g., ceramics or metal oxides) can be so transferred. Among all the wet deposition techniques, evaporation-based dip coating or dipping lacquers is the simplest, facile to scale up, low-cost, waste-free, and low energy consumption. It is suitable for large surface film generation on complex structures, including porous architectures (e.g., with low volumetric flux).

Much work has been reported on wet deposition-based dip-coating, and many of them are focused on material transfer from suspension (direct transfer) or from precursor chemicals (ionic transfer). Wet deposition-based dip-coating allows a wide range of density and viscosity of the liquid carrier system for the preparation of thin layers over flat and circular substrates. Material is transferred on the interfacial substrate while withdrawing from a mixture or solution by entrainment. The competition between the capillary force and the viscous drag force at the time of the withdrawal determines the thickness of the layer (e.g., polymer layer) that is formed on the substrate. The thickness is also influenced by the withdrawal speed, shape, and physical properties of the substrate. In one of the pioneering works of the dip-coating process, the thickness of the film is determined by h=0.94l_{c}Ca^{2/3} which is known the Landau-Levich-Derjaguin (LLD) equation. Here, l_{c}=√(γ/ρg) is the capillary length, Ca=ηU/γ is the capillary number and γ and η are the surface tension and the viscosity of the suspension respectively; U is the withdrawal speed of the substrate and g is the acceleration with respect to gravity.

Dip-coating thin-film generation techniques are commonly used in various industrial applications, including corrosion protective layer, roller lubrication process, printing technologies, and wire coating, biosensors, hybrid coatings, and others. In recent works, dip-coating has been demonstrated to enable size-based separation of particles from suspensions by tailoring capillary force and the viscous drag force at the liquid-gas interface. A polymer layer formed from the LCS governs particle entrainment during withdrawal onto the substrate, which changes with the withdrawal speed of the substrate from the suspension and the percentage of the polymer binder in the solution. In some example studies, silicone oil is used as the liquid carrier system to carry neutrally buoyant polystyrene micro-beads particles (20 μm-250 μm). Three regions are reported after withdrawal which are explained with capillary number (Ca); no particle entrainment for low Ca regime; cluster of micron size particle entrainment at medium Ca regime and individual large particles are entrained at high Ca regime.

Larger inorganic micro-scale particles are commonly used in manufacturing industries (e.g., brazing powder, metal filler, and 3D printing powder). Common powder particle manufacturing processes includes gas atomization, plasma atomization, and plasma rotating electrode process. These processes are commonly known as droplet-based particle fabrication techniques and generate a spherical particle size distribution with a large standard deviation (i.e., the particles are polydisperse). The size distribution often follows a continuous exponential pattern commonly expressed with Rosin-Rammler expression. A narrow particle size range is desirable for their utilization in various manufacturing domains (e.g., powder sintering, metal injection molding, powder bed fusion). Mono-disperse particle fabrication is difficult, costly, and challenging and oversized particles are very common. Different filtration processes are employed to reduce the polydispersity as post-processing steps, including membranes or motion of the bubble. However, their size separation capacity can be limited and can become energy intensive. Capillary filtration via dip coating is a relatively facile process and has been demonstrated in separating bi-disperse particles from density matching dilute suspensions. However, inorganic-micro particles have a higher density and will generate slurries if added to LCS. Thus, capillary filtration may not be a viable option. There is a need, therefore, for systems and methods to easily sort particles by size for applications where particles are (to be) disposed (e.g., coated) on substrates, especially for larger particle sizes (e.g., over 1 μm average diameter).

### SUMMARY

The present disclosure provides methods of selective particle capture based on entrapment. Particles are entrapped on a substrate while the substrate is submerged in a liquid (e.g., solution of solvent and solute), as compared to entrained as the substrate is withdrawn from the liquid in entrainment approaches. An interfacial layer may be used to entrap the particles on the substrate surface. The interfacial layer may include or be formed of a solute in a solution, where the solute may be, for example, a binder, such as a polymer binder. The interfacial layer may act to apply a viscous force to nearby particles. A centrifugal force may be applied to particles due to their motion in the solution, in some embodiments, due to an external energy applied to the particles through the solution, such as stirring and/or agitation. A balance of the viscous force and centrifugal force (e.g., in combination with other force(s) present) may lead to selective entrapment of particles. For example, size-and/or density-selective entrapment from a larger particle population in solution may occur. In some embodiments, particles (e.g., large inorganic micro-particles, having d_{avg}>1 μm) are entrapped to solid substrate surfaces submerged in density-mismatched liquid mixtures, prior to substrate withdrawal. Therefore, polydisperse particles may be selectively entrapped on a substrate according to the desired application, without the need for extensive pre-processing (e.g., filtration).

In general, when a substrate is dipped in a solution, such as a polymer solution, a thin viscous layer of solute (e.g., polymer) is formed due to fundamental molecular interactions leading to reversible or irreversible adsorption layer. The adsorbed layer may include (i) interphase substrate (e.g., metal) and, in some embodiments, native oxide, (ii) interface, and (iii) interphase solute (e.g., polymer). The thickness of this adsorbed interfacial layer can range from a few nanometers to a couple of micrometers. The interfacial layer may provide a viscous force against the particles. Relatively large particles are prone to natural sedimentation. For relatively large particles (e.g., micron-sized particles), ensuring dispersion of such sediment-prone particles may benefit from, or require, an external energy field (e.g., magnetic, mechanical, acoustic, or electrical) to induce hydrodynamic flow in the liquid for submerging the substrate. A centrifugal force may be applied, or enhanced, by such externally applied energy. By controlling the process parameters, nano to micro-particles may be entrapped in (e.g., on) an interfacial solute layer during relative motion.

A dimensionless “entrapment factor” number can be used to correlate the particle entrapment with various parameters to design systems for specific particle selectivity. Experimental results show that larger entrapment factors result in entrapping larger particles, which can be controlled with multiple parameters of an entrapment process. Entrapment processes disclosed herein can selectively entrap a wider range of poly-disperse particle mixtures than capillary-based filtration processes.

Methods disclosed herein can entrap particles in or on structures with low volumetric flux, for example in hard-to-reach places such as porous or hollow structures with narrow openings. Larger inorganic micro-scale particles (d_{avg}>1 μm) are commonly used in manufacturing industries (e.g., brazing powder, metal filler, and 3D printing powder) that will generate slurries if added to solutions. Their uniform and substantial delivery as a higher yield (e.g., volume transfer and coverage) coating is highly desirable.

Solution-derived material transfer or deposition of thin (e.g., <5 μm) films of particles is of great interest due to the drive for miniaturization, system integration, and complex design through optimization. Coatings of particles generated using entrapment methods disclosed herein have widespread application for decoration, sensors, microfluidics, supercapacitors, surface passivation, protection, and lubrication, among other potential applications. As another example, surface properties can be better controlled through the roughness imparted by impregnated microparticles (e.g., having d_{avg} of ˜1-20 μm) entrapped using methods disclosed herein to create a rougher surface than nanoparticles (which may be entrained) to tune the coefficient of friction. Methods disclosed herein may achieve cheaper and faster coating or particle transfer that can directly benefit applications, such as orthopedic implants, light-weight stress-shielding prosthetics, bio-medicine, protective layers, meta-materials, printing, transfer printing, substrate transfer, and material joining. Additionally, methods disclosed herein can be utilized for removing solid or soft impurities from suspension or mixture sediment. Methods disclosed herein may also be used for separation of biological microorganisms and pollutants from suspensions. Selective entrapment processes disclosed herein have an additional benefit in that they are free from clogging (in contrast to membrane filtration). Simple control over particle size at the time of filtration using methods disclosed herein makes them attractive for industrial and biological applications.

Any two or more of the features described in this specification, including in this summary section, may be combined to form implementations not specifically explicitly described in this specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 is a process flow diagram for methods of entrapping particles on a substrate, according to illustrative embodiments of the present disclosure;

FIG. 2 is a schematic diagram of mechanisms for particle transfer onto a thin layer over a substrate (not to scale) where panel (a) shows particle entrainment as the substrate is withdrawn and panel (b) shows particle entrapment to the substrate while submerged, where panel (a) is useful to understanding embodiments of the present disclosure and panel (b) is in accordance with illustrative embodiments of the present disclosure;

FIG. 3 is a schematic diagram of an LCPS in a stirred tank agitation chamber with (a) an unbaffled tank and anchor impeller and (b) a baffled tank and pitched blade stirrer, where (c) and (d) show their respective particle flow characteristics, according to illustrative embodiments of the present disclosure;

FIG. 4 illustrates a particle entrapment mechanism in a vicious solute (e.g., binder) layer for a submerged substrate where panel (a) illustrates particles entrapped in solute (polymer chains) and panel (b) illustrates forces that act on a particle during entrapment, according to illustrative embodiments of the present disclosure;

FIG. 5 illustrates forces acting upon a non-deformable, adhering particle in a flow field parallel to the surface and gravitational force (FG) acting perpendicular to the x-z plane (left), and a magnified region of particle-surface interface where adsorbed polymer chains create a contact radius (a) enabling van der Waals (F_{vdW}) and depletion (F_{π}) forces to create adhesion (right), according to illustrative embodiments of the present disclosure;

FIG. 6 shows a relative rheogram window for LCPSes with the parameters involved and potential workable boundaries where φ_{b} and φₚ denotes the volume fraction of solute (e.g., binder) and particles, respectively; superscript (+) and (−) represents the increase and decrease in volume fraction, according to illustrative embodiments of the present disclosure;

FIG. 7 illustrates a process flow for forming structures using a template substrate that is then joined after entrapping particles, according to illustrative embodiments of the present disclosure;

FIG. 8 illustrates experimental measurement of polymer layer thickness on a substrate using a round cut method, for tests performed in accordance with illustrative embodiments of the present disclosure;

FIG. 9 plots (a) a comparison of theoretical and experimental polymer layer thickness with the capillary number (both circles and squares denote theoretical results and triangles denote experimental results), and (b) experimentally observed variation of the entrapped particle size with variation of polymer layer thickness, for tests performed in accordance with illustrative embodiments of the present disclosure;

FIG. 10 illustrates a visualization of particle entrapment at binder percentage schematic in the top row and shows corresponding experimentally derived images in the bottom row for (a) Zone A, (b) Zone B, (c) Zone C of an entrapment factor (20 μm scale bars), for tests performed in accordance with illustrative embodiments of the present disclosure;

FIG. 11 plots variation of forces (left axis, where circles denote viscous force, squares denote centrifugal force) and an entrapment factor (triangles) as a function of percentage of binder, for tests performed in accordance with illustrative embodiments of the present disclosure;

FIG. 12 plots variation of particle size as a function of variation of an entrapment factor with three Zones of entrapment factor shaded in yellow and the transition from one Zone to another Zone shaded in light green, for tests performed in accordance with illustrative embodiments of the present disclosure;

FIG. 13 plots particle distribution of different zones of an entrapment factor in tests performed in accordance with illustrative embodiments of the present disclosure; and

FIG. 14 plots variation of coverage and particle density as a function of an entrapment factor in tests performed in accordance with illustrative embodiments of the present disclosure.

### DETAILED DESCRIPTION OF CERTAIN EMBODIMENTS

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

The present disclosure provides, inter alia, systems and methods for disposing particles on substrates by using particle entrapment. Entrapment facilitates size-selective disposition (as shown experimentally infra) that can be beneficial for certain applications where particle regularity is important, for example where particles will be sintered or for sensing applications. Particles may be entrapped on a substrate from a liquid carrier system (LCS) in which the particles are dispersed (referred to together as a “liquid carrier particle system” (LCPS)). An LCPS may include a solution comprising a solvent (or solvents) and a solute (or solutes). The solute may influence the viscosity of the solution, as is the case with binders, such as polymer binders. A substrate may be at least partially submerged in the LCS solution in order to entrap particles dispersed in the LCPS. A solute in the LCS solution may form (e.g., spontaneously) an interfacial layer on the substrate. The interfacial layer may act to apply viscous force on particles in the LCPS. A force balance between forces driving particle motion (e.g., centrifugal forces) and the viscous force may lead to selective particle entrapment. That is, depending on, for example, the chosen solvent(s), solute(s), particles, and substrate and their relevant properties (e.g., respective density, size, solubility/miscibility, and volume fraction), certain particles may be entrapped while others are not. In this way, LCPSes can be designed to selectively dispose subpopulations of particles (e.g., according primarily to particle size) on a substrate.

In some embodiments, a method for selectively entrapping particles (e.g., for size filtering particles) includes entrapping particles in (e.g., on) an interfacial layer, wherein the interfacial layer is disposed on a submerged surface of a substrate. The substrate may be at least partially (e.g., entirely) submerged in a solution including at least one solute and at least one solvent. The interfacial layer may be formed from the solute, for example spontaneously due to thermodynamics. The particles may be dispersed in the solution and entrapped out of the solution. Entrapping may include applying a balance of viscous force and centrifugal force to the particles. An interfacial layer may include a binder. Thus, in some embodiments, a method for selectively entrapping particles (e.g., for size filtering the particles) may include providing a substrate at least partially submerged in a liquid having particles dispersed therein; and entrapping the particles from the liquid in (e.g., on) an interfacial layer on a surface of the substrate. The interfacial layer may be formed from a solute in the liquid.

During entrapment, adhesion forces caused by solute (e.g., polymer) adsorption and presence in solution should be sufficient to prevent the particle from rolling on a surface with an interfacial layer of the solute or falling off due to gravity once stirring stops, otherwise poor coverage develops. Once one particle sticks to the surface, this increase in surface roughness increases the likelihood that other particles will adhere to the same region, serving effectively as a nucleation event.

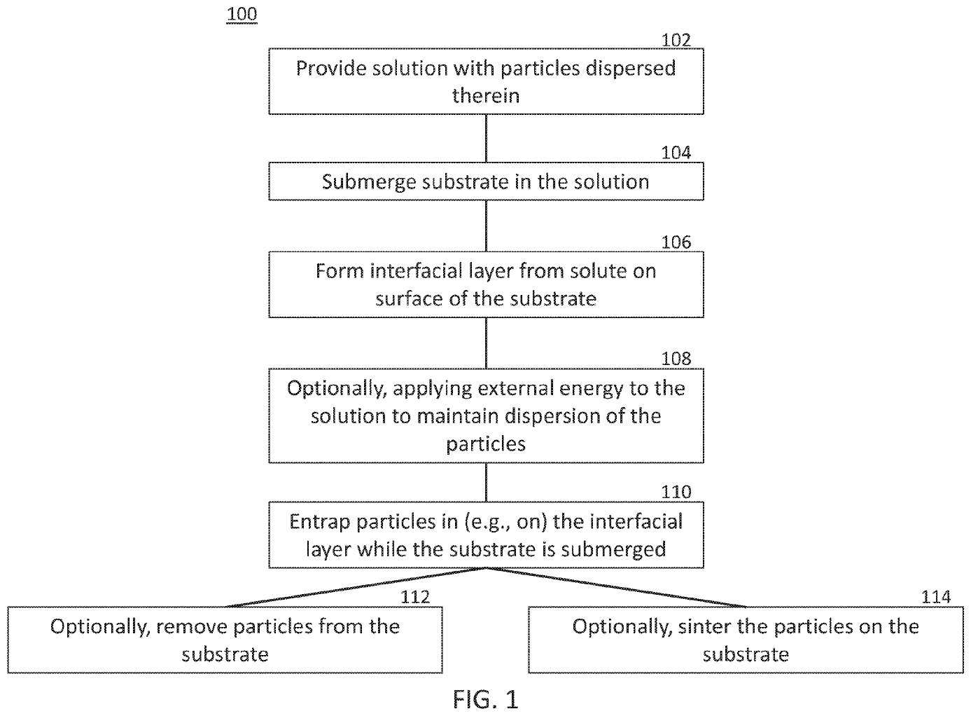

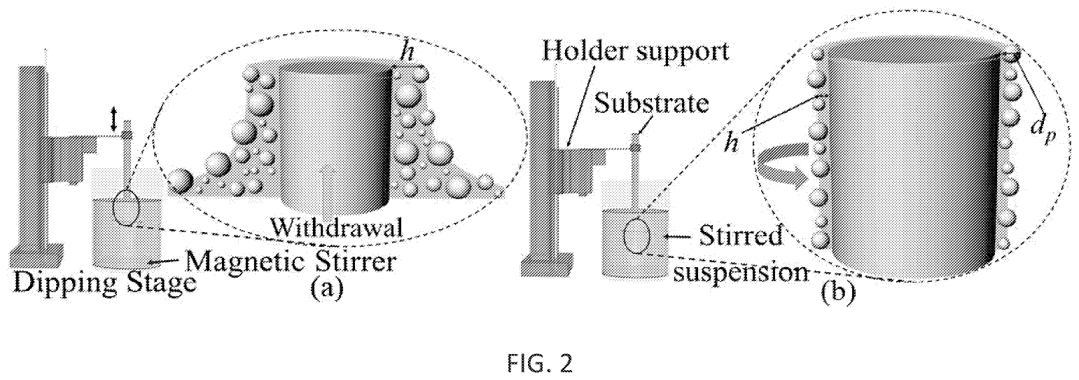

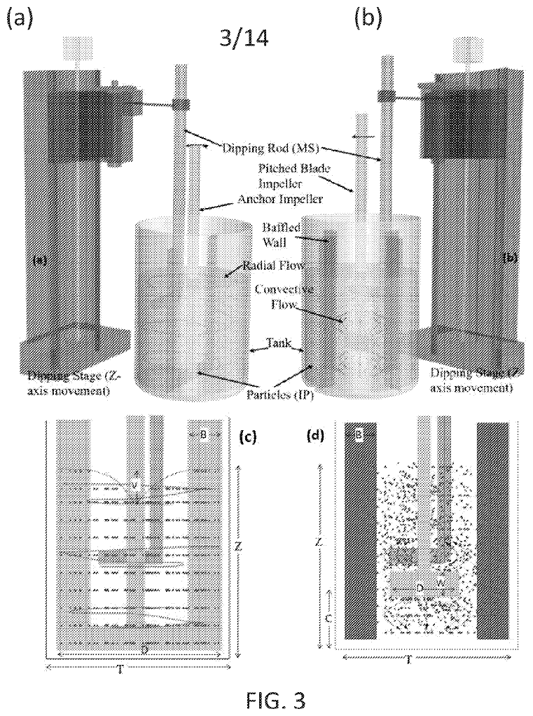

FIG. 1 provides a flow diagram for illustrative methods 100 for selectively entrapping particles on a substrate. In step 102, a solution is provided with particles dispersed therein. The solution includes a solvent and a solute. The solute may be a binder, such as a polymer binder. In step 104, a substrate is at least partially submerged in the solution. (Panel (b) of FIG. 2 shows an example of an arrangement to at least partially submerge a substrate in a solution to entrap particles, and FIG. 3 shows more elaborate setups.) In step 106, an interfacial layer is formed from the solute on at least a portion of a surface of the substrate that is submerged. The interfacial layer may form spontaneously on the submerged portion of the substrate surface. Thermodynamic equilibration may cause spontaneous formation of such an interfacial layer, as is commonly the case for substrates disposed in, for example, polymer solutions. In some embodiments, an interfacial layer is allowed to form prior to particles being entrapped (step 110 explained infra). In optional step 108, external energy is applied to maintain dispersion of particles in the solution. Such external energy may be desirable or necessary depending on, for example, particle size or density being sufficiently large or high as to otherwise cause natural rapid sedimentation. External energy may be applied as mechanical, electrical, magnetic, or acoustic energy, for example. Particular choice of type of energy may be influenced by properties of particles being dispersed (e.g., magnetic energy for magnetic particles). Commonly, stirring or agitation (e.g., shaking or ultrasonic vibration) may be used. In step 110, particles are entrapped in (e.g., on) the interfacial layer while the substrate is submerged. As explained further subsequently, the entrapment may exhibit size selectivity, which may be beneficial for certain applications.

Steps 106-110 may occur (essentially) simultaneously. Moreover, steps 102-110 may be performed multiple times in order to entrap particles with different characteristics in each successive entrapping, for example to entrap particles having different size distributions in different iterations. Properties of an LCPS may be altered between iterations, for example volume fraction of solute (e.g., polymer binder) may be changed (e.g., increased) after each entrapping (as explained further infra).

A comparison of entrapment processes in accordance with FIG. 1 to typical entrainment (e.g., dip-coating) processes is schematically illustrated in FIG. 2, where panel (a) shows an entrainment setup, where particles are disposed on the substrate due to a balance between capillary and viscous forces upon substrate withdrawal, and panel (b) shows an entrapment setup, where particles are disposed on the substrate due to a balance of centrifugal and viscous forces. A detailed schematic illustration of the force balance in an LCPS with a polymer binder as solute is shown in FIG. 3, where panel (a) shows the interfacial layer formed from polymer chains adsorbed on the substrate surface acting to entrap some particles while others remain in bulk (solution) and panel (b) illustrates the force balance for a single particle.

Referring again to FIG. 1, in optional step 112, particles are removed from the substrate after the substrate is removed from the solution (e.g., by scrapping or dissolution of the interfacial layer with a solvent). Such particles may then be used for other applications having now been size filtered. Solute (e.g., polymer binder) that was part of the interfacial layer may need to be separated from the particles in order for the particles to be useable for a desired application, which may be accomplished by, for example, centrifugation or sedimentation. Alternatively, in optional step 114, particles remain disposed on the surface of the substrate and are sintered after the substrate is removed from the solution, for example to permanently join portions of the substrate with the sintered particles. In some embodiments, particles may simply remain (e.g., without sintering) on the substrate for use in a desired application.

Further details about different aspects of methods for selectively entrapping particles and constituent elements of LCPSes are given in the following sections organized by headers. Headers are provided for the convenience of the reader and are not intended to be limiting with respect to the claimed subject matter. One of ordinary skill in the art will readily appreciate that details provided under one header may be combined with details provided under another header within contemplated embodiments of the present disclosure.

### Non-Dimensional Factor

Given the complex dynamics of LCPSes, it is useful to characterize a given LCPS by a dimensionless number that will be referred to as an “entrapment factor.” As illustrated further below in the Examples, an appropriately constructed entrapment factor can be used to predict selectivity of particle entrapment. Traditional dip-coating process uses dimensionless numbers (e.g., capillary number or bond number) that consider the dipping parameter, substrate, and mixture characteristics. Such dimensionless numbers work well for entrainment in solid-liquid-gas interfaces, which can predict the properties of the entrained film. However, in the present disclosure, particles are entrapped, for example into thin polymer interfacial layers by relative motion, which may be similar to the collision of particles through media in cold spray coating. As the particle is entrapped at a solid-liquid interface (since the substrate is submerged), the capillary number (Ca=ηU/γ) and bond number (Bₒ=(dₚ/2l_{c})2) are not appropriate because they do not accurately capture relevant characteristics of entrapment processes. For example, the substrate is generally (though not necessarily) motionless while submerged during entrapment of particles, which would make capillary number unsuitable to explain the entrapment phenomenon.

A new non-dimensional “entrapment factor” can be introduced to characterize particle entrapment on submerged substrates. In some embodiments, in submerged conditions, entrapment of the particles depends on competition between (at least or solely) viscous force, Fᵥ=1.7009×3πηd_{PvP}, and centrifugal force, Fc, acting on the particles. The viscous force can be expressed as Fv =where η, d_{P} and v_{P} are viscosity of the solution having particles dispersed therein (LCPS), average diameter of the particles, and velocity of the particles, respectively. The centrifugal force can be expressed as F_{c}=ρVvₚ²/r, where ρ, V, and r are density, average volume, and rotational radius of the particles, respectively.

Since the rod is dipped at the center, r can be taken to be the radius of the substrate where it is a rod. The constant 1.7009 is used to observe the effect of surface on drag force and may be different for different (e.g., non-rod) substrate geometries. Viscous force helps particles remain in an interfacial layer on a substrate; conversely, centrifugal force drives particles out of the interfacial layer back into bulk (solution). Thus, the entrapment factor (Ef) can be defined as a ratio of viscous force and centrifugal force, which can be calculated by the following equation:

$$\\ Entrapment Factor ( Ef ) = \frac{{F}_{V}}{{F}_{C}} = \frac{C ( 3 π η {d}_{p} r )}{ρ {Vv}_{p}}$$

Where C is a constant that accounts for drag force (e.g., can be defined as 1.7009 for rod substrates, as discussed). An entrapment factor based on a balance of viscous and centrifugal forces may use a different equation when factoring in all or other constraints (additionally or alternatively), for example where a substrate has a different (non-rod) geometry or an LCS solution includes additional constituents (e.g., co-solvent(s), stabilizer(s), dispersant(s)). In some embodiments, an entrapment factor for the particles in the solution at the interfacial layer is in a range of from 1,000 to 100,000 and the entrapment factor is defined as a ratio of viscous force to centrifugal force. For example, an entrapment factor for an LCPS can be in a range of from 5,000 to 50,000 (e.g., of from 7,500 to 45,000). An entrapment factor can reflect the heterogeneity of an LCPS due to density mismatch between particles and the solution their dispersed in, which can be a factor of eight or higher.

An entrapment factor can be controlled by changing characteristics of an LCPS including, for example, volume fraction of particles or solute(s) (e.g., polymer binder), applied external energy (e.g., by controlling amount applied or directionality of the force field that is applied, for example to affect velocity of particles in the LCPS), or choice of solvent(s) and solute(s). (Material choice, shape, and size of particles and substrate(s) may be dictated by desired application or may also be available for changing to control the entrapment factor.) An entrapment factor may be controlled to have a certain value, or range of values, based on a desired size (e.g., average diameter) or density of particle to be entrapped. In some embodiments, particles are size-sorted, wherein size-sorting the particles includes changing the entrapment factor to entrap different portions of the particles. Changing an entrapment factor may include increasing viscosity of the solution, decreasing velocity of the particles, or both (e.g., as discussed below).

### Solutes (Binders)

As discussed supra, viscous forces may be imparted (e.g., enhanced) to particles at a substrate interface due to the presence of solutes in the solution in which the substrate is submerged. Such solutes may adsorb to a surface of a substrate. A solute may be, for example, an adhesive, a polymer, an oligomer, a binder, or an ionic liquid. In some embodiments, a solute is a polymer binder. For example, poly (methyl methacrylate), polystyrene, or poly (lauryl methacrylate) may be used as polymer binders in an LCS solution. In some embodiments, a solution for entrapping particles includes a binder that includes one or more of a carbonyl functional group, an aromatic functional ground, and an alkyl functional group, which may be particularly well-suited for surface adsorption for certain substrates, depending on chemistry. In general, a solute forms an interfacial layer at a substrate surface when the substrate is submerged in solution. The interfacial layer may preferentially have a thickness corresponding to a size of particles. A solvent for a solute may be a poor solvent, a good solvent, or a theta solvent. A solvent may be polar (e.g., water) or non-polar (e.g., an organic, such as toluene or xylene). A solvent is generally a liquid solvent. Multiple solutes may be used in a single solution.

An interfacial layer of solute on a substrate may formed spontaneously upon submerging the substrate in solution. An interfacial layer may have a thickness of, for example, 5 nm to 50 μm (e.g., 5 nm to 10 μm or 10 nm to 5 μm). The layer thickness depends on solute (e.g., polymer) and solvent type, their volume fraction, and the substrate. A solute may be present in solution in a volume fraction in a range of from 0.1% to 25%, for example from 0.5% to 20% or from 1% to 13%. In some embodiments, a concentration of solute may be changed to perform successive size-sorting entrapments as different concentrations of solutes results in different layer thicknesses, which in turn results in different viscous forces and a different entrapment factor. In some embodiments, changing concentration causes viscosity of a solution to be increased to promote entrapment of larger particles (e.g., after entrapment of smaller particles). Therefore, different entrapments, for example performed with different solute concentrations, may have different size distributions. For example, a first entrapment may have a lower average diameter than in a second entrapment where the second entrapment occurs after increasing viscosity of the solution (e.g., by increasing solute concentration).

Without wishing to be bound by any particular theory, adsorbed polymer can control large metal particle adhesion to metal surfaces. The amount of polymer adsorbed depends on the polymer, solvent, polymer concentration in the solution, and the substrate material (e.g., metal/alloy composition). For nickel, ab initio modeling suggests that functional groups like aromatic rings adsorb more strongly, suggesting stronger adhesion for polymers with similar chemistry. Polymer chain ends can also preferentially adsorb to the surface so a molecular weight dependence on adsorbed polymer is expected. Adsorption isotherms can explain how polymer functional groups and molecular weight affect surface adsorption. Adsorption can be measured for different polymer/solvent combinations and fit to the Freundlich and Langmuir adsorption isotherm models, to extract out the adsorption isotherm constants (K_{L} and K_{F}). The Freundlich model is defined by:

$$\\ {q}_{e} = {K}_{F} {C}_{e}^{{}_{} 1 / n} .$$

The Langmuir model is defined by:

$$\\ {q}_{e} = \frac{{q}_{m} {K}_{L} {C}_{e}}{1 + {K}_{L} {C}_{e}} .$$

In both models, qₑ is the polymer adsorbed per area and Cₑ is the concentration of polymer in solution qₘ is the saturated polymer adsorbed per unit, K_{F} and K_{L} are adsorption isotherm constants (for the Freundlich and Langmuir models, respectively), and n is the Freundlich isotherm constant. (qₑ and Cₑ are experimental values and the others are fit values.) Furthermore, the Freundlich isotherm constant (n) provides information on adsorption strength and the Langmuir parameters will describe the adsorbed polymers stability. To collect the necessary information for qₑ, first, the specific surface area of the particles can be measured using Brunauer-Emmett-Teller (BET) adsorption of N₂. If BET proves challenging, an alternative approach is to use particle scanning electron microscopy (SEM) images to calculate a surface area. Second, particles can be mixed with different concentrations (20-400 mg/L) of polymer for 1 h at room temperature for adsorption to occur. Particles can be centrifuged out and the concentration difference of the solution before and after adsorption can be determined by gravimetry to determine the amount of polymer adsorbed. The qₑ over these concentration sweeps will be then fit following the Freundlich and Langmuir equations above. By completing these tasks, the isotherm constants can be ascertained, describing which polymers more strongly adhere to which substrates, describing which polymer-solvent mixtures could significantly affect particle-substrate adhesion. Therefore, on these bases, polymer-solvent selection criteria can be developed for a range of polymers, solvents, and substrates described herein. While particle properties do not factor directly into solute adsorption characteristics, they may be important considerations for other aspects of an LCPS that factor synergistically with solute adsorption considerations.

Without wishing to be bound by any particular theory, polymer coating on the surface improves adhesion between particle and surface by increasing the adhesion area and van der Waals forces. Atomic Force Microscopy (AFM) can be used to measure the adhesion forces between a polymer coated particle tip and a polymer coated substrate. Polymers can be covalently attached to the tip and substrate using literature procedures for surface initiated polymerization (SIP). SIP can create densely grafted polymer chains of different lengths off the substrate and AFM probe tip yielding different polymer-polymer contact areas for each system. Longer polymer chains increase the contact area of the tip, while shorter chains reduce the area. AFM force curve measurements can be made in solvent during the approach and retraction from the surface. Custom AFM probes can be made from particles as disclosed herein. If manufacturing custom tips proves challenging, colloidal silica tips can be purchased and functionalized with polymers using the same SIP procedure, as an alternative method. Since no free polymer is present, only bound, the force curve will be dictated by the van der Waals force, F_{vdw}=−Aa/6h², where A is the Hamaker constant, which is specific for each polymer in specific solvent, a is the radius of contact, and h is the distance of the tip from the substrate. Radius of contact can be plotted as function of polymer molecular weight (A is independent of molecular weight) to understand how the polymer attached to the surface affects radius of contact. To connect this fundamental study to practice, polymers can be adsorbed to a substrate and AFM tip. Force measurements can be made to correlate the amount of polymer adsorbed to surfaces to the contact area using the Hamaker constants and relationships from the densely grafted brushes. By completing these tests, the nature of particular polymer-substrate-particle interactions can be investigated to determine optimized selections for particular applications.

Non-adsorbing polymers in solution can generate depletion forces as surfaces come in contact. Without wishing to be bound to any particular theory, depletion forces (F_{Π}) can contribute to adhesion of large particles to surfaces at high polymer concentrations. Understanding the contribution of depletion forces to overall adhesion enables design of new systems. AFM force curves can be generated as described in the preceding paragraphs under this section using clean tips and surfaces in polymer solutions. These force curves will be a sum of the van der Waals (F_{vdw}) and depletion forces (F_{Π}). Using the constants derived above for F_{vdw}, the F_{Π}can be isolated as a function of osmotic pressure (Π) and depletion layer thickness (Δ) by using the equation F_{Π}=πΠ(h+2rₒ)(h−2Δ), where rₒ is the radius of the hard spherical tip. The rₒ can be determined through a literature reported procedure or an average radius calculated from SEM images of the particles can be used. Force curves can be corrected for the F_{vdw} and then fit to the depletion force equation to calculate Π and Δ. The Δ is the criterion for adhesion; however, at relatively low concentrations (<1 wt %), it becomes constant as solute (polymer) concentration increases. As a result, the Δ should have little effect on the magnitude of F_{Π}. Instead, F_{Π}should be dictated by Π solely, which increases with increasing concentration and the quality of the solvent for the polymer (indicated by the Flory-Huggins interaction parameter, χ). To understand how these parameters change adhesion in this system, concentration sweeps (0.1-10 wt %) of each polymer can be performed to elucidate Δ and Π as a function of concentration for a given system. AFM force data can be fit to determine these two parameters. Different solvents can be selected to explore future polymer-solvent systems that improve adhesion if depletion forces are significant, targeting good quality solvents (estimated by Hansen solubility parameters and χ), to increase adhesion. Therefore, surface interactions in LCPSes at the interfacial layer on a substrate can be designed based on concentration and solvent quality as they affect polymer adhesion of (e.g., metal) particles to surfaces.

### Dippability

When a substrate (e.g., thin rod) is dipped in an LCPS with external stirring energy, it will experience a sway of load, namely buoyancy force, capillary force, centrifugal force, and viscous drag force due to the resultant viscosity and stirring of the pseudo suspension. The resultant effect may cause two things: (i) rod deformation or deflection due to the range of forces experienced from the mixture and (ii) particle removal from the rod surface due to viscous drag force. Both of them may negatively impact the uniform particle transfer process at the solid-liquid interface. Understanding the relationship between stirring energy and volume fraction of non-Brownian particle-laden LCPS, the resultant viscosity, and the impact on dipped rod deflection, generally referred to as “dippability,” can assist in counteracting these potential negative consequences.

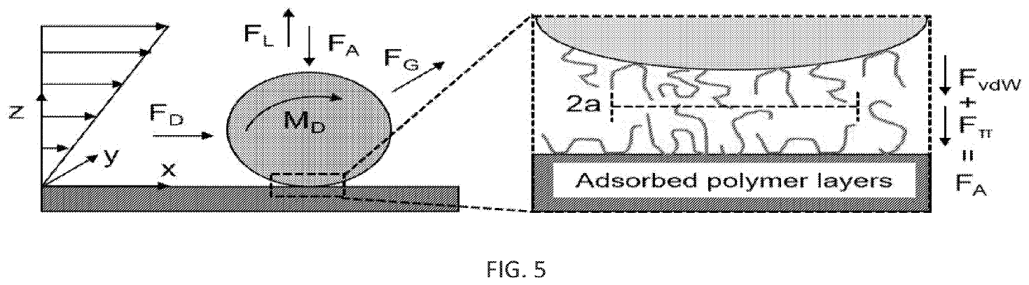

The adhesion of particles to a vertical surface in a flow field perpendicular to gravity and parallel to the surface requires an adhesion force (F_{A}) that overcomes all the opposing forces of drag (F_{D}), lift (F_{L}), gravity (F_{g}), and the moment of surface stresses (M_{D}), as summarized visually in FIG. 5 (left). Most theory assumes deformable particles create significant contact area for van der Waal forces to be the dominate adhesion force. However, rigid (e.g., metal) particles and surfaces are several orders of magnitude stiffer than polymer latexes and thus, do not significantly deform, reducing the contact radius and adhesion force. Thus, large metal particles do not readily adhere to surfaces without a “glue” mediating the adhesion force between the particle and surface.

Adsorbed polymer chains can create a deformable boundary layer of solvent swollen polymer chains (FIG. 5 (right)) that deform as the particle interacts with the surface, creating a larger contact area than possible with the original non-deformable surfaces. Additionally, an adsorbed polymer layer should change the van der Waals forces (F_{vdw}). Another potential adhesion force arises when metallic particles move closer together than the size of a non-adsorbing polymer chain, generating osmotic pressure and a depletion force (F_{Π}) causing the particles to adhere to the surface. The strength of these forces depend on solvent type, polymer type, and adhered polymer coverage. An understanding of how adhesion forces develop with polymer-solvent mixtures for metal surfaces (e.g., with metal particles and/or substrates) can aid in controlling adhesion and thus particle coverage.

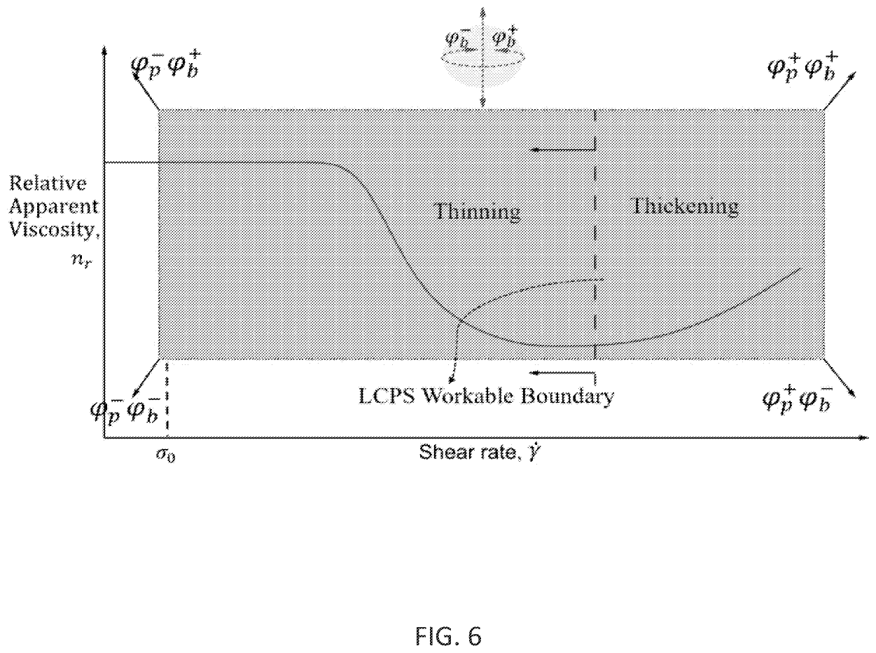

At high particle concentration, a LCPS may demonstrate pseudoplastic behavior and may even reach the jamming density. The transition from liquidus to semisolid (shear-stress fluid) mixture can make it unfit for dipping. This transition has been observed; the change in rheological behavior with volume fraction of the trio (binder, solvent and particles) can range from Newtonian to non-Newtonian (shear thinning and shear thickening), which is shown visually in FIG. 6.

A dipped rod will behave as a cantilever beam, and the buoyancy force will act as the axial force, while a shear force, viscous force, and centrifugal force will act along the transverse direction. The resultant of these forces will determine the deflection, δ. Analytical measurement of these forces will require the determination of rheological parameters (a) yield stress, (b) apparent viscosity, and (c) storage modulus recovery. Characteristics of LCPS formulations can be investigated to correlate the data with Herschel-Bulkley fluid expression to determine the dippability: σ=K\dot{γ}n+σ₀, where σ₀ is the yield stress, K is the consistency coefficient which is analogous to apparent viscosity, and n is the flow behavior index. A rotational rheometer (e.g., MCR-302, Anton Paar) with both parallel plate and cone plate geometry (e.g., 50 mm flat plate and 50 mm 10 cone plate) can be used to make these determinations. Furthermore, fluid velocity due to application of external energy (e.g., stirring) can be an important parameter for determining transverse forces that needs to be determined to ensure even particle coverage (e.g., limited deflection of a substrate). As stirring speed can be set as the just suspended speed, Nⱼₛ, (discussed in the subsequent section), we can assume minimum slippage, similar to laminar flow. Moreover, the length of any impeller/stirrer can be selected close to the diameter of a dipping tank. Thus, the radial speed of rotation of the mixture near to the substrate can be assumed steady. Similarly, the speed variation along the vertical direction can also be neglected in this experiment. The rotational speed of the particles can be assumed as the same as the speed of the stirrer near the substrate. By investigating these parameters, the forces can be determined considering the dipping reactor, mixture rheology, and stirring speed.

### Application of Kinetic Energy to Solutions

Density mismatch between particles and the solution (e.g., LCS) in which they are dispersed may be large. For example, some particles may have a density in a range of 5-10 g/cm³ and the solution may have a density of 0.5-2 g/cm³. Such a large density mismatch may thermodynamically favor sedimentation of the particles. Ensuring continued dispersion of such sediment-prone particles may involve use of an external energy field (e.g., magnetic, mechanical, acoustic, or electrical) to induce hydrodynamic flow in a solution. Different particles may be more amenable to different energy fields being applied, for example magnetic fields may be used with magnetic particles but unsuitable for use with non-magnetic particles. Smaller particles may require less, or no, externally applied energy to remain dispersed. Therefore, particles may be suspended or pseudo-suspended in a solution (e.g., LCPS).

An easy approach to maintaining a state of pseudo-suspension is by stirring and/or agitation. Stirring may be accomplished with, for example, an impeller or magnetic stir bar. Agitation may be accomplished with, for example, ultrasonics. Stirred tank agitation is commonly used for the mixing and dispersion of solid particles in a fluid-like fashion. Depending upon the agitation parameters (e.g., baffled or unbaffled tank; propeller, anchor or turbine type impeller geometry and location), the rotating impeller can provides radial motion (mean flow), fluctuating axial motion (turbulent eddies), or a combination in the process fluid. For example, using a pitched blade turbine and propeller type impeller in a baffled tank will generate two ring vortices above and below the impeller facilitating mixing via top to bottom flow. Whereas, with anchor type impeller, nearly the same angular velocity is observed between impeller and fluid, which will generate a tangential laminar flow pattern in an unbaffled tank. Without wishing to be bound to any particular theory, providing laminar-like flow may minimize the micro-turbulent eddies in the particle-laden media, which will facilitate the uniform transfer of inorganic particles along the cylindrical surface.

A glass, flat bottom chamber, with or without baffles, may be used to hold an LCPS. A center-mounted pitched blade impeller or anchor impeller may be used. In a baffled stirred tank with a pitched blade impeller, the dominant flow structure in the system may be two ring vortices above and below the impeller, creating a convective flow in the LCPS. The speed of the LCPS will vary spatially, and maximum speed may be achieved right below the impeller. Similarly, a higher convective speed has been observed nearer an impeller than a tank wall, which facilitates mixing. On the other hand, an unbaffled tank with an anchor impeller may induce a radial motion to the mixture, which may facilitate dispersion. An anchor impeller may have a same size as a tank diameter. This may result in layered particles in the mixture, and their speed can be assumed the same as the angular speed of the impeller. An unbaffled mixing tank may produce a vortex at the center, and the height may be maintained at a minimal level by controlling the rotational speed of the impeller. A pitched blade impeller with a 1/12 ratio for the tank diameter and impeller diameter may be used. The impeller speed at which no solid particles in a mixer remain stationary at the bottom of a tank is expressed as suspended speed Nⱼₛ. The Zwietering correlation for minimum suspending speed can be expressed as:

$$\\ {N}_{js} = S {}_{} {( \frac{g ( {ρ}_{s} - {ρ}_{L} )}{{ρ}_{L}} )}^{0.45} \frac{{x}^{{}_{} 0.13} {d}_{p}^{{}_{} 0.2} {v}^{{}_{} 0.1}}{{D}^{{}_{} 0.85}}$$

where S is the zwietering constant, ρₛ solid density, ρ_{L} liquid density, X solid loading (wt %), dₚ particle diameter, v kinematic viscosity of the liquid, and D impeller diameter. The minimum power consumption is another parameter regarding solid-liquid suspension, which can be expressed as: Pⱼₛ=ρₛₗNₚ(Nⱼₛ)³D⁵; where ρₛₗ is the slurry density, and Nₚ dimensionless power number. Both of these relationships are suitable for relatively low (<10 wt %) dilute solid loading and may be only approximate for semi-dilute and concentrated solid-loading (<50 wt %). Particles in an unbaffled tank may experience a laminar-like radial flow by the incompressible fluid around the substrate, creating an irrotational flow with no-vorticity. Micro-turbulent eddies may be formed in a baffled tank that will enhance the gravitational effect on the moving particle and cause non-uniform particle transfer (e.g., entrapment). FIG. 3 provides an illustrative comparison of flow characteristics (c-d) for (a) an unbaffled tank and anchor impeller and (b) a baffled tank and pitched blade stirrer.

### Particles

Entrapment may be used to dispose (e.g., coat) particles on a substrate surface and/or size-sort polydisperse particles. Generally a wide variety of particles may entrapped using methods disclosed herein. Particle density and size may impact entrapment so particular LCSes may be well-suited for certain particles. Particles may be or comprise, for example, metal, polymer, ceramic, dielectric, or semiconductor. Particles may be inorganic particles. Particles may be or comprise an oxide (e.g., have an oxide passivation layer). Particles may be at least partially amorphous or at least partially crystalline (e.g., polycrystalline). Particles may have a core-shell structure (e.g., with a hollow core). Particles may be functionalized, for example with a ligand or grafted with a polymer. Particles may be soft (e.g., latex) or rigid. Particles may have any shape, including, for example, spherical shape. In some embodiments, particles have an average diameter (e.g., largest dimension, for nonspherical particles) in a range of from 50 nm to 50 μm (e.g., from 1 μm to 20 μm). For example, particles can be exclusively microparticles. The average diameter may be a number average or a volume average. Average particle size may be determined by dynamic light scattering (DLS) or similar scattering techniques or by microscopy (e.g., SEM). Particles may be able to be sintered, for example where ones of the particles are sintered after being entrapped on a substrate. In some embodiments, particles are brazing powder. In some embodiments, particles are a volume fraction of the solution of no more than 20%.

### Substrates

A variety of substrates may be used to entrap particles. Generally, any material may be used for or included in a substrate. For example, metals, ceramics, dielectrics, semiconductors, plastics, or composites may be used as substrate materials. In some embodiments, a substrate is a metal substrate. A substrate may be amorphous or crystalline (e.g., polycrystalline). Generally, a substrate may have any shape. For example, a substrate may be curved (e.g., may be a rod). A curved substrate may be preferred to have a radius of curvature substantially larger (e.g., by at least an order of magnitude) than particles being entrapped thereon, in order to avoid potentially detrimental curvature effects. The subsequent Examples use to a metal rod for its geometric simplicity (thereby simplifying understanding of flow behavior at the surface), but other may be used, such as rectangular solids, spheres, meshes, or wireframes. Substrates may be complex. In some embodiments, entrapped particles can be removed by scraping from a substrate or by using solvent to dissolve the solute (e.g., binder) in which the particles are entrapped. If solute is dissolved in solvent, subsequent centrifugation or sedimentation may be used to separate now-size-sorted particles from the binder and solvent for subsequent use (e.g., where continued presence of binder would be detrimental).

A substrate may be a template (e.g., for a component or product) (e.g., a cellular or lattice template). The template may have an open lattice architecture, for example as commonly formed in the additive manufacturing (AM) arts. A relative density of the architecture may be 1-20% (e.g., 3% to 10%). A method disclosed herein may be used to entrap particles at one or more node points of the template. Metal porous structures (including cellular/lattices) are interesting candidates for the development of wings and fuselage structures, among many other applications. Lattice topology may be able to demonstrate superior and predictable performance if designed and manufactured properly. Manufacturing open-cell lattice architectures can be a complex and costly process, especially in mesoscale (size of ˜2-5 mm) unit sizes which are often unattainable. Bending-dominated cuboid structures have been constructed that have, for example, 3.8% to 8.6% relative density. Fabricating metal structures with 1D metallic wires/rods can be advantageous as compared to other forms of materials (e.g., powder, 2D sheet, liquid metal). Nonetheless, as-formed structures may have several challenges including: (a) convergence of the strut to a point node and (b) delivering the interlayer ink for solid-state transient liquid phase (TLP) joining. The convergence issue is a mechanical challenge and can be addressed with better design and bending accuracy, including a closed loop system. However, the common interlayer brazing alloy for TLP are inorganic micro-particles (e.g., Ni or Cu or Ag-based) that can be delivered to hard-to-reach places via particle entrapping methods disclosed herein. Subsequent sintering or other coalescence processes can then improve joining.

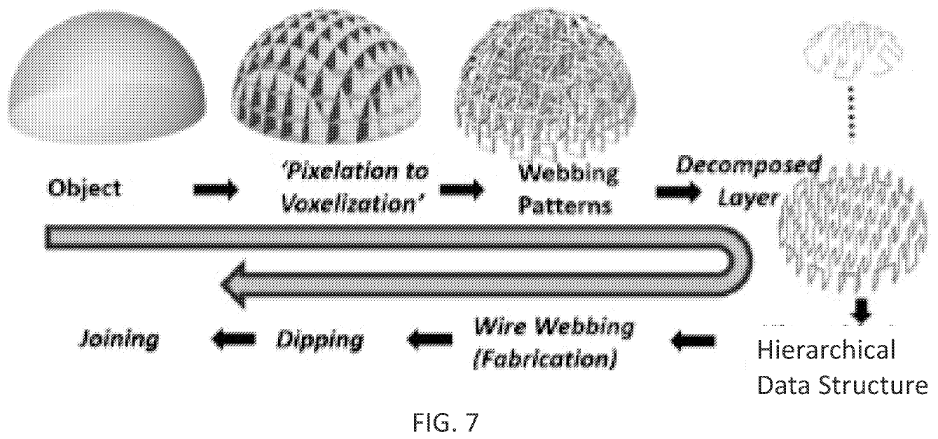

FIG. 7 shows a process flow diagram for creating a desired object using methods disclosed herein. The process includes starting with a design of an object to be formed. Using computer aided design (CAD) software, the object can be converted to a hierarchical data structure that includes a series of layers to be formed. The hierarchical data structure is then used to form a wire webbing template substrate in a physical fabrication process. The formed structure can be dipped to entrap particles (e.g., at the node points of the template). Joining (e.g., sintering) may then be performed to finalize the structure. In some embodiments, any solute (e.g., polymer binder) will readily be removed (e.g., vaporized) during joining. In a process according to FIG. 7, particles that are entrapped on a template surface may preferably be brazing powder, metal filler, or 3D printing powder to promote enhanced joining.

Surface treatment may be applied to a substrate so that interfacial layer formation is spatially modulated and particles are selectively entrapped on only certain portions of a substrate or to varying degrees (e.g., spatial densities or size distributions) for different portions of a substrate. For example, a surface treatment may be patterned on a substrate in a way that inhibits polymer adsorption to the substrate where the treatment has been applied.

A substrate is generally motionless and any stirring and/or agitation is applied to the liquid (e.g., solution) in which it is at least partially submerged. However, in some embodiments, centrifugal force is applied to particles by relative motion where a substrate is rotated and/or agitated in a solution while the solution is otherwise unperturbed.

### EXAMPLES

In order that the application may be more fully understood, the following examples are set forth. It should be understood that these examples are for illustrative purposes only and are not to be construed as limiting in any manner.

A series of tests were performed to determine certain suitable characteristics for entrapping particles on a substrate surface, which will be described in detail. The LCPS used in the tests included a solute (binder) and solvent (1, 3-dioxolane) to deliver solid brazing particles (Nicrobraz 51). In these tests, nothing further was included in the LCPS but, in some embodiments, additional constituents are included in the LCPS (e.g., co-solvent(s), stabilizer(s), dispersant(s)). Poly (methyl methacrylate) (PMMA) was used as the binder. The density of the binder and the solvent are 1.17 g/cm³ and 1.06 g/cm³, respectively, at room temperature (RT=25° C.). Both solute (granular) and solvent (liquid) were procured from Sigma Aldrich, USA. A magnetic stirrer was used for two hours at RT to dissolve the solute into the solvent. Table 1 (infra) shows the viscosity of the solution at different binder percentages, as measured with an Anton Paar MCR 302 Rheometer with a parallel plate/plate geometry. The binder concentration is varied at different intervals ranging from 1% to 13% for the sorting of the particles within the range of particles used in the mixture. All viscosity measurements were taken at RT.

The brazing powder (Nicrobraz 51; Wall Colmonoy Corporation, Ohio; spherical diameter range ˜0-100 μm) was sieved with Gilson Performer III shaker through stainless steel 635 Mesh (20 μm) to make an initial reduction in polydispersity and was analyzed using SEM. The average diameter of the particles was found to be 5.69 μm. For submicron size particles, the electrostatic force and van der Waals forces become prominent for coagulation due to their possession of a large specific surface. However, for larger particles (>1 μm), the specific surface area is reduced, which makes them non-interacting and non-agglomerating spherical solid particles in the liquid matrix (non-Brownian regime). Thus, no dispersant was needed. The density of the particles is 7.8 g/cm³, and the particle to liquid density ratio >7. Due to this density mismatching, fast sedimentation will occur naturally, which will accumulate at the bottom of the dipping vessel and create a phase separation. External kinetic energy in the form of stirring/agitation was applied in the mixing reactor to counter the gravitational force. A cylindrical magnetic stirrer was used; the stirrer's length and diameter were 14.88 mm and 5.95 mm. The stirring was used to create a pressure difference (normal stresses), and the particles lifted off and stayed suspended so long as stirring continued, creating a dispersed mixture of particles in the LCS (a pseudo suspension).

The substrate used was a cylindrical AISI 1006 mild steel rod with an average diameter of 1.1 mm (procured from ClampTite LLC). Rod samples were cleaned in an ultrasound bath with acetone for 10 minutes at 50° C., to remove any surface contaminant and passive film. Before dipping, the mixture was stirred for 15 minutes at a rotation of 150 rpm for stabilizing. The dipping reactor used was a 20 mL 95020-0CV vial, screw top; clear borosilicate glass, round bottom with the dimension of 75.5 mm×22.5 mm. The rod was mounted on a Z-axis stage controlled with a Flashcut CNC controller. A high-precision bipolar stepper motor (SANYO) connected with a computer was used to control the dipping speed within ±2% precision, which is controlled using G-code.

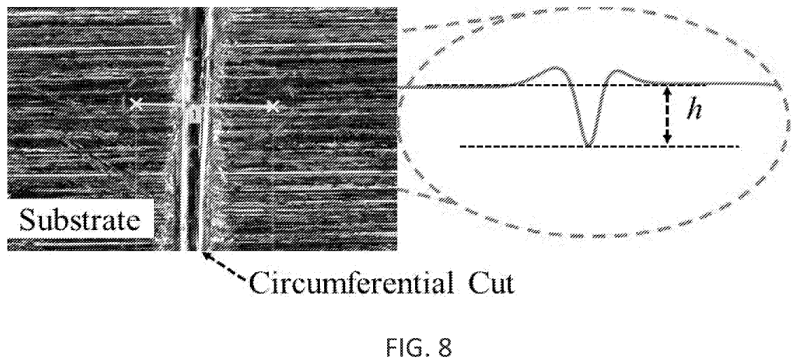

The rod was entered at the center of the dipping reactor at a speed of 10 mm/s during the experiment. The dwelling time was a total of 90 minutes. Stirring continued for the first 50 minutes, and then the stirrer was switched off. The mixture settled down in the remaining 40 minutes creating the phase-separated mixture. This ensured that no particles were floating in the mixture to entrain the substrate while withdrawing. Afterward, the substrate was withdrawn from the particle-laden mixture very slowly at 0.1 mm/s to minimize any vibration. The solvent evaporated quickly from the substrate leaving the transparent binder and the entrapped particles. The liquid film thickness was measured with 3D profile depth variation using VHX 7000 Digital 4K microscope (KEYENCE Corp., IL) at 1500X. A narrow groove is created with a round edge cut on the substrate in three different locations. The profile depth was measured and averaged as shown in FIG. 8. The high-resolution 4K images of the dipped rod are analyzed with image J software. To ensure statistical significance, ten samples (regions) are randomly selected for each measurement (e.g., particle count, surface coverage) in each sample which is then averaged for further calculation (infra). While plotting the experimental values, the standard error was calculated for the error bar and 2σ (95.45% confidence level) bar is used in the plotted data to demonstrate the repeatability.

The volume fraction of the particles was measured by the ratio of the volume of particles and the total volume of the mixture (solute, solvent, and particles) as ϕₚ=Vₚ/(Vₚ+Vₛₒₗᵤₜₑ+Vₛₒₗᵥₑₙₜ); here Vₚ is the volume of particles. The volume fraction of the particles was kept constant (ϕₚ=10%) for the experiments as previous work found that mixtures with ϕₚ<20% remain in the Newtonian regime at a low share rate, \dot{γ}. Only the binder percentage was varied to observe the entrapment phenomenon. The viscosity of the suspension was measured by using the Krieger-Dougherty equation using the viscosity of the solution η_{ϕ}=η₀(1−ϕ/ϕₘₐₓ)−Bϕₘₐₓ; here ϕₘₐₓ is the maximum volume fraction of the particles and B is the Einstein coefficient. Packing for monodisperse sub-micron spherical particles (ϕₘₐₓ) can range from 0.52 to 0.74 with some staking scheme. However, their random close packing (RCP) density is about 0.64, which may increase up to ˜0.74 for poly-disperse particles. For a rigid sphere under sheared suspensions, the maximum particle volume fraction is reported as ϕₘₐₓ=0.68 and ϕₘₐₓ=0.67. The value of B is used as 2.5 to calculate the viscosity of the suspension is listed in Table 2 (infra).

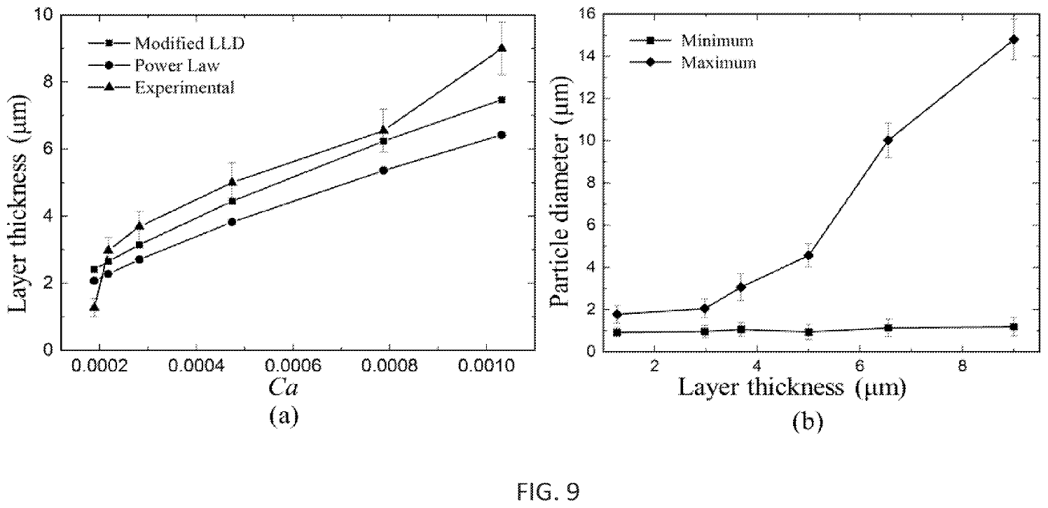

In the classical dip-coating process, particle entrainment to the substrate is due to the competition between the viscous force and the capillary force during the withdrawal of the substrate. To verify the present model, the substrate was dipped into the solution without the particles and stirring energy. To minimize the convective flux (entrainment of polymer chain) during withdrawal, a very low withdrawal speed (0.001 mm/s) was used, for which the film thickness was measured using the methodology discussed supra. To compare the experimental result of this system, the polymer layer thickness was also determined with the modified LLD equation (h_{LLD}=1.34r_{f}Ca^{2/3}) and power-law equation

$$\\ ( {h}_{power} = \frac{1.34 {r}_{f} {Ca}^{{}_{} 2 / 3}}{1 + 2.53 {Go}^{{}_{} 1.95} / ( 1 + 1.79 {Go}^{{}_{} 0.95} )} ) ,$$

where r_{f} is the radius of the fiber, Go is the Goucher number expressed as Go=r_{f}/l_{c}, where l_{c} is the capillary length. The data are plotted in Panel (a) of FIG. 9, which shows the experimental thickness is slightly higher than the theoretical value. This variation can be attributed to the very low withdrawal speed (0.001 mm/s) during these experiments. In addition, the size of the entrapped particle and their variation is shown with the entrained polymer layer thickness in Panel (b) of FIG. 9. The size of the maximum entrapped particles increases with the polymer layer thickness; however, the maximum particle size increases sharply when the polymer layer thickness ≥5 μm.

TABLE 1

| | | Particle | | | |
|---|---|---|---|---|---|
| | Velocity of | Volume | Viscosity of | Density of | Surface |
| Binder | Particle | Fraction | the Solution | the Solution | Tension |
| (%) | (m/s) | (%) | (mPa*s) | (g/cm³) | (mJ/m²) |
| 1 | 8.64 × 10⁻³ | 10 | 0.752 | 1.037 | 34.374 |
| 2 | 8.64 × 10⁻³ | 10 | 0.868 | 1.038 | 34.449 |
| 4 | 8.64 × 10⁻³ | 10 | 1.128 | 1.042 | 34.598 |
| 7 | 8.64 × 10⁻³ | 10 | 1.908 | 1.047 | 34.821 |
| 10 | 8.64 × 10⁻³ | 10 | 3.191 | 1.052 | 35.044 |
| 13 | 8.64 × 10⁻³ | 10 | 4.210 | 1.057 | 35.268 |

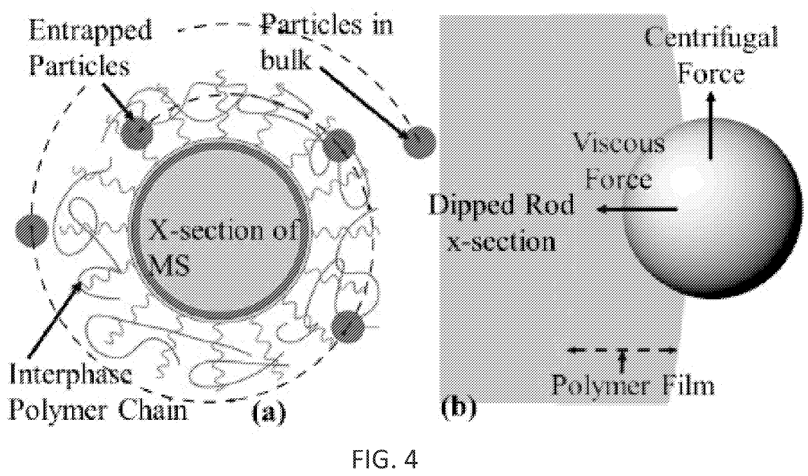

The particles are entrapped into the thin layer that is due to the relative motion of the substrate and suspension, as described supra (see also FIG. 4). As the stirring speed was low, it assumes minimum slippage, like laminar flow. Moreover, the length of the stirrer is close to the diameter of the dipping reactor. Thus, the radial speed of the mixture near the substrate can be assumed steady. Similarly, the speed variation along the vertical direction can also be neglected in these experiments. The rotational speed of the particles can be assumed as the same as the stirrer speed (πdN/60, where d is the rotation diameter of the particles and Nis the RPM) near the substrate.

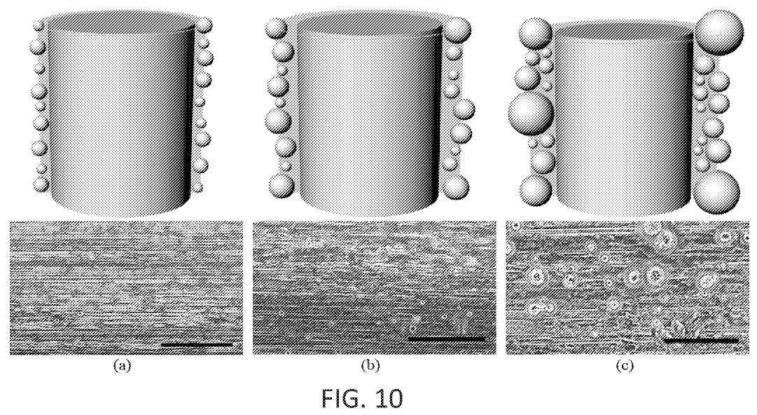

When the substrate is dipped into the solution, a polymer layer was adsorbed on the substrate spontaneously (polymer film, in accordance with Panel (b) of FIG. 4). The thickness of the polymer layer was dependent on the binder concentration. As the particle comes closer to the substrate, the viscous polymer film will entrap the particle with the viscous force, while the centrifugal force acting on the particle will push it to roll and drive them towards the bulk. The balance between these two forces causes the entrapment of the particle on the substrate, for which the mechanism is visualized in FIG. 4. The experimental parameters and the physical properties of the solution are listed in Table 1. As discussed in the methodology section, the entrapped particle size and their coverage on the substrate were measured from the microscope image, which was analyzed by ImageJ software. The size variation of the entrapped particles is shown in FIG. 10 with schematic and actual microscope images. The results of the experiments were divided into three different zones (Zone A, B and C) based on the particle sizes entrapped into the polymer layer on the substrate. From FIG. 10, a qualitative positive correlation between entrapped particle size and the binder volume fraction can be observed, for which the quantitative data are presented in Table 2. Such a correlation can be used for the batch-wise filtration of the polydisperse particles.

TABLE 2

| | Viscosity | | Average | Maximum | Minimum | Range of |
|---|---|---|---|---|---|---|
| | of the | Surface | Particle | Particle | Particle | Particle |
| Percentage | Suspension | Coverage | Diameter | Diameter | Diameter | Diameter |
| of Binder | (Pa*s) | (%) | (μm) | (μm) | (μm) | (μm) |
| 1 | 9.86 × 10⁻⁴ | 0.564 | 1.23 | 1.78 | 0.92 | 0.80 |
| 2 | 1.14 × 10⁻³ | 0.993 | 1.37 | 2.05 | 0.96 | 1.09 |
| 4 | 1.48 × 10⁻³ | 2.348 | 1.72 | 3.06 | 1.06 | 2.00 |
| 7 | 2.50 × 10⁻³ | 2.937 | 2.13 | 4.57 | 0.94 | 3.63 |
| 10 | 4.19 × 10⁻³ | 3.478 | 3.98 | 10.02 | 1.13 | 8.89 |
| 13 | 5.53 × 10⁻³ | 5.673 | 5.66 | 14.80 | 1.19 | 13.61 |

Since the rod is dipped at the center, r was considered as the radius of the rod. The constant 1.7009 was used to observe the effect of surface on drag force. The viscous force helps the particle remain in the polymer layer on the substrate; conversely, the centrifugal force drives the particles out of the polymer layer. Thus, the entrapment factor is defined here as the ratio of viscous force (Fᵥ) and the centrifugal force (F_{c}), which is calculated by the following equation.

$$\\ Entrapment Factor ( Ef ) = \frac{{F}_{V}}{{F}_{C}} = \frac{1.7009 ( 3 π η {d}_{p} r )}{ρ {Vv}_{p}}$$

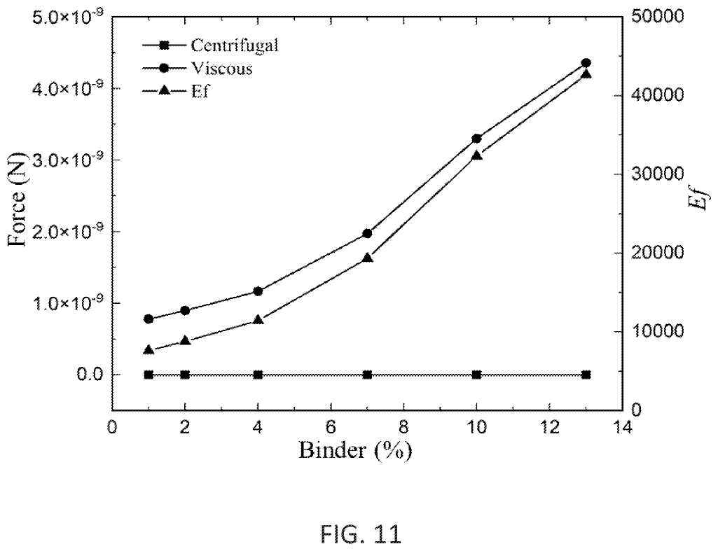

The force variation acting on the particles is shown in FIG. 11. As the particle distribution (mass) and rotational diameter remain fixed, the centrifugal force acting on the particles remains constant. The viscous force changes with LCS viscosity by modulating the binder concentration. Increasing the stirring energy or decreasing the binder viscosity both will reduce the entrapment factor and hence the particle entrapment. However, the centrifugal force remains constant by keeping the same stirring rpm (150 rpm), which is close to the just suspended speed of the mixture. The increase in entrapment factor indicates a clear dependency of layer thickness and the size of entrapped particles. This entrapment factor helps us to compare the entrapment of different-sized particles with the binder volume fraction. The variation of the entrapment factor with the concentration of the binder is presented in FIG. 11.

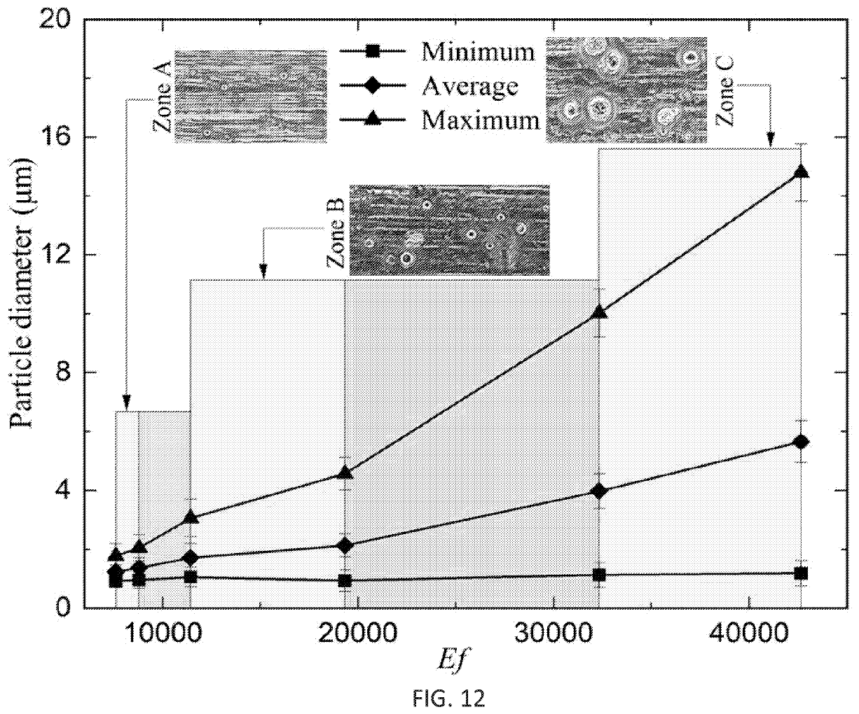

As the thickness of the polymer layer in the submerged condition depends on the viscosity of the dispersion, the viscous force increases with the entrapment factor, and hence larger particles are entrapped into the polymer layer. FIG. 12 depicts the variation in entrapped particle size into the polymer layer as a function of the entrapment factor. For the particle separation analysis, three different zones are defined, which are shown as the yellow regions in FIG. 12. The first zone is the small particle entrapment zone, which is Zone A (7.6×10³<Ef<8.8×10³) where small particles (0.92 μm<d_{p,min}<0.96 μm; 1.78 μm<d_{p,max}<2.05 μm) are entrapped into the polymer layer. Zone B (11.4×10³<Ef<19.3×10³) contains particle size range of 0.94 μm<d_{p,min}<1.06 μm and 3.06 μm<d_{p,max}<4.57 μm. Finally, entrapped particles size range is 1.13 μm<d_{p,min}<1.19 μm and 10.02 μm<d_{p,max}<14.8 μm in Zone C (32.3×10³<Ef<42.6×10³). Moreover, the transition zones (8.8×10³<Ef<11.4×10³ and 19.3×10³<Ef<32.3×10³ indicating the transition from Zone A to Zone B and Zone B to Zone C respectively) are shown as the light green region in FIG. 12.

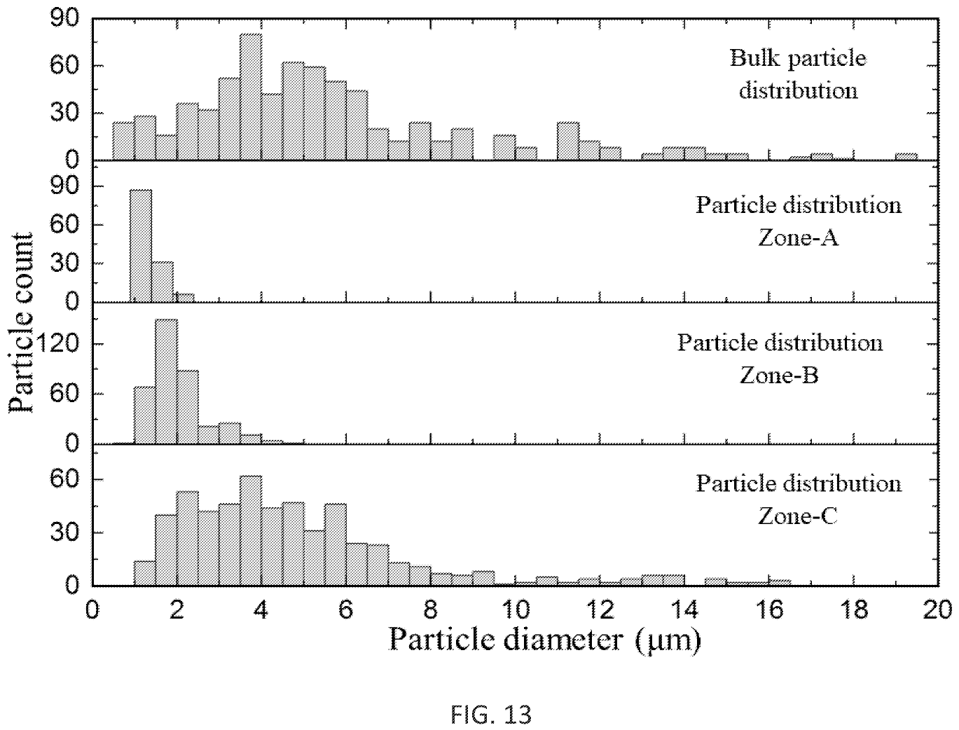

To measure the effectiveness of the process, the sorted particles are counted and diameter is measured for their distribution. FIG. 13 represents the sorted particle distribution after dipping for each zone (Zones A, B and C). Compared to the bulk particle distribution, it can be observed that the particles with small diameters are only entrapped into the substrate in Zone-A. Similarly, clearly distinct particle distribution can be observed in Zones B and C as well. It can also be seen that by increasing the entrapment factor, particle counts can be increased, and thus the efficiency of the process will depend upon the sorting range.

The minimum particle size entrapped in the three zones is almost similar; however, the maximum particle size entrained into the polymer layer increase with the increase of the entrapment factor. The maximum particle size increases rapidly when the value of the entrapment factor is greater than 20000. Successive filtration in Zone A enables this process to separate the small particles (0.92 μm<dₚ<2.05 μm) from the suspension of poly-disperse particle mixture, leaving the medium and the large particles in the suspension. Larger particles (dₚ>10.0 μm) are only left into the suspension when the binder volume fraction is increased (Zone B). This unique process can repeat itself for the batch-wise separation of particles from both bi-disperse and poly-disperse particle mixtures (LCPSes). To expedite the filtration process, a larger reactor and multiple substrates can be used that will increase the transfer surface area. The entrapped particles can be removed by scraping from the substrate or by using solvent to dissolve the binder.

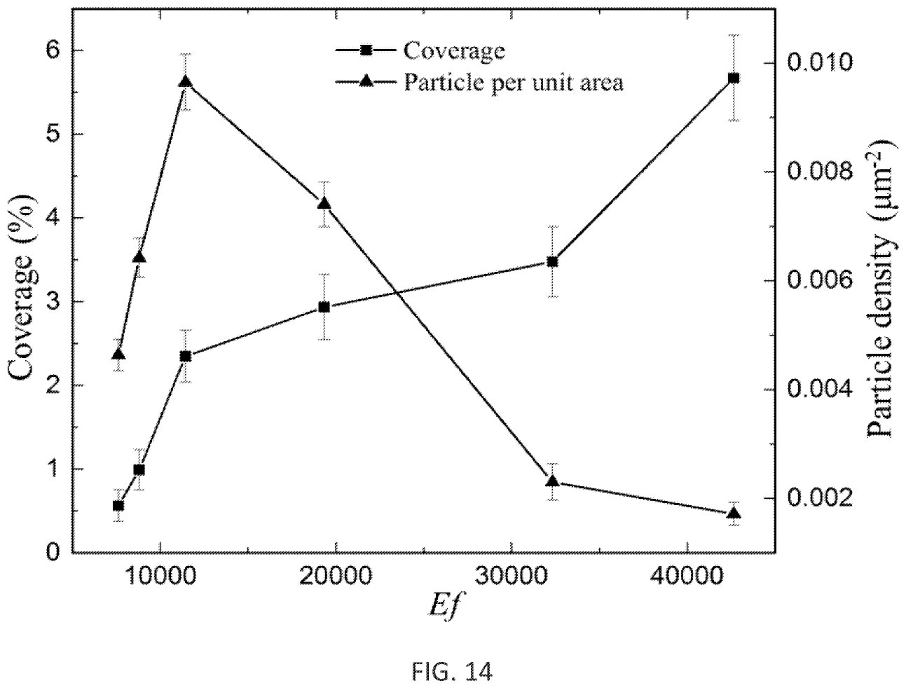

Two additional matrices, coverage and particle density, were measured and are plotted in FIG. 14. Ten randomly selected region over the substrate were imaged, and particles and their diameters were counted using ImageJ software. Coverage is calculated by taking the ratio of the covered and uncovered area after withdrawal by the entrapped particles. Particle density is the number of particles per unit area, which is averaged from the ten samples collected for measurement. A higher coverage rate increase is observed at low and high Ef value in our experiment. At lower Ef, the coverage increases rapidly; however, no cluster formation is observed. With a higher Ef value, the entrapped particle size exceeds the cluster effect. The particle density increases till Ef<11500 and, then starts to decrease. This is because larger particles are entrapped as the entrapment factor increases.

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1. A method for selectively entrapping particles on a substrate the method comprising:
providing a solution comprising a solute and a solvent, wherein particles are dispersed in the solution;
submerging at least a portion of a substrate in the solution;
forming an interfacial layer comprising at least a portion of the solute on a surface of the at least a portion of the substrate; and
entrapping at least a portion of the particles in (e.g., on) the interfacial layer on the surface while the at least a portion of the substrate is submerged.

2. The method of claim 1, wherein entrapping the at least a portion of the particles comprises applying a balance of viscous force and centrifugal force to the at least a portion of the particles.

3. The method of claim 2, wherein the viscous force is applied due to the interfacial layer and the centrifugal force is applied by stirring the solution.

4. The method of claim 1, comprising applying external energy to the solution during the entrapping.

5. The method of claim 1, wherein the at least a portion of the particles are entrapped from a state of suspension or pseudo-suspension in the solution.

6-7. (canceled)

8. The method of claim 1, wherein the interfacial layer is formed spontaneously upon submerging of the at least a portion of the substrate in the solution.

9. The method of claim 1, wherein an entrapment factor for the particles in the solution at the interfacial layer is in a range of from 1,000 to 100,000 and the entrapment factor is defined as a ratio of viscous force to centrifugal force.

10. The method of claim 9, wherein the ratio of viscous force to centrifugal force is given by the relation:
$$\\ \frac{C * 3 π η {d}_{p} r}{ρ {Vv}_{p}} ,$$
where η is viscosity of the solution having the particles dispersed therein, dₚ is average diameter of the particles, r is rotational radius of the particles, ρ is density of the particles, V is average volume of the particles, vₚ is velocity of the particles, and C is a constant.

11. (canceled)

12. The method of claim 9, comprising size-sorting the particles, wherein size-sorting the particles comprises changing the entrapment factor to entrap different portions of the particles.

13. The method of claim 12, wherein changing the entrapment factor comprises increasing viscosity of the solution, decreasing velocity of the particles, or both.

14. The method of claim 1, wherein the at least a portion of the particles is a first portion of the particles and the method comprises changing a concentration of the solute in the solution and subsequently entrapping a second portion of the particles.

15. (canceled)

16. The method of claim 14, wherein the first portion of the particles and the second portion of the particles have different size distributions.

17. The method of claim 14, wherein the particles in the first portion have a lower average diameter than the particles in the second portion.

18. The method of claim 1, comprising removing the substrate from the solution and collecting the particles from the substrate

19. The method of claim 1, wherein the solute is present in the solution in a volume fraction in a range of from 0.1% to 25%

20. The method of claim 1, wherein the particles are dispersed in the solution in a volume fraction of no more than 20%.

21. The method of claim 1, wherein the solute is a binder.

22-23. (canceled)

24. The method of claim 1, wherein the substrate is a template having an open lattice architecture.

25-27. (canceled)

28. The method of claim 24, comprising sintering the at least a portion of the particles.

29. (canceled)

30. The method of claim 1, wherein the substrate remains in a fixed position during the entrapping.

31. The method of claim 1, wherein the particles have an average diameter in a range of from 50 nm to 50 μm.

32. The method of claim 1, wherein the particles are brazing powder, metal filler, or 3D printing powder.

33-42. (canceled)
